(19) United States
(12) Patent Application Publication
(10) Pub. No.: US 2006/0013519 A1
(43) Pub. Date: Jan. 19, 2006

(54) Four-point contact ball bearing

(76) Inventor: Masafumi Fukunaga, Kanagawa (JP)

Correspondence Address: SUGHRUE MION, PLLC, 2100 PENNSYLVANIA AVENUE, N.W., SUITE 800, WASHINGTON, DC, 20037, US

(21) Appl. No.: 10/538,299

(22) PCT Filed: Dec. 4, 2003
(86) PCT No.: PCT/JP03/15544

§ 371 Date: Jun. 10, 2005

(30) Foreign Application Priority Data
Dec. 16, 2002 (JP) 2002364162

(51) Int. Cl. F16C 19/00; F16C 33/58

(52) U.S. Cl. 384/450; 384/516

(57) ABSTRACT

Problems to be solved by the present invention are to suppress increase in friction torque in an operation under an applied preload thereby suppressing heat generation and wear of a bearing, and to realize a low-noise and low-vibration operation at a high-speed rotation in addition to enhancement of a bearing life.

Let d designate the diameter d of the ball (17) in a four-point contact ball bearing (11). Let Dₚ denote the diameter of a pitch circle of plural balls (17) disposed between both raceway surfaces (13a, 15a). Let L₁ designate an inter-ball distance between the adjacent balls (17) on the pitch circle having the diameter Dₚ. Let r denote a curvature radius of each of grooves serving as raceway surfaces (13a, 15a), which circumscribe the ball (17) on the outer and inner races (13, 15), respectively. Let α designates a contact angle between the ball (17) and each of the raceway surfaces (132a, 15a). According to the present invention, these variables d, Dₚ, L₁, r, and a are controlled according to predetermined relations. Thus, in a condition under an applied preload, in which the axial gap SA is negative, increase in friction torque can be suppressed. Thus, heat generation and the wear of a bearing can be suppressed.

### TECHNICAL FIELD

The present invention relates to a four-point contact ball bearing and, more particularly, to an improvement of an ultrathin-walled four contact ball bearing enabled to suppress heat generation and wear thereof by restraining increase in friction torque an operation thereof under a preload applied thereto and also enabled to achieve increase in bearing life thereof in addition to realization of a low-noise and low-vibration operation thereof at high speed rotation thereof.

### RELATED ART

FIG. 13 shows an example of a CT scanner apparatus that is a kind of medical equipment. This CT scanner apparatus 1 irradiates X-rays, which are generated by an X-ray tube 2 and limited in intensity to a predetermined value by a wedge filter (not shown) and a slit (not shown), onto an object 3. X-rays transmitted by the object 3 are received by a detector 5. A computer (not shown), which receives an output of this detector 5, forms an X-ray transmission image.

A cylindrical frame 6 equipped with the X-ray tube 3 and the detector 5 is rotatably supported on a body frame 8 through a rolling bearing 7. A tomographic image got by checking a cross-section of the object 3, which is to be inspected, from all angles can be obtained by rotation-driving the cylindrical frame 6.

Generally, the rolling bearing 7 is formed so that the inside diameter thereof is set to be a large diameter being equal to or more than 700 mm. Thus, the rolling bearing 7 is what is called a ultrathin-walled rolling bearing whose cross-section is extremely small in comparison with the diameter thereof.

A load acting on the rolling bearing 7 used in the CT scanner apparatus 1 is a synthesis load of a radial load, an axial load, and a moment load. This synthesis load is a relatively light load.

Therefore, a roller bearing, whose withstand load is large, is unnecessary. Thus, a CT scanner apparatus 1 using back-to-back combined angular ball bearings 8a, 8b shown in FIG. 14 or a four-point contact ball bearing, whose balls are in two-point contact with each of the raceway surfaces of outer and inner races, as the rolling bearing 7 has hitherto become widely used.

Such back-to-back combined angular ball bearings 8a, 8b and the four-point contact ball bearing have a commonality in that the ball bearing undergoes a bidirectional axial load. However, the back-to-back combined angular ball bearings 8a, 8b are constituted by combining two bearings with each other. Thus, as compared with the four-point contact ball bearing that is constituted only by a single bearing, the width dimension w1 of the angular ball bearings 8a, 8b becomes large. Consequently, the angular ball bearings are disadvantageous in reducing the size, weight and cost thereof.

Thus, recently, the number of the CT scanner apparatuses each using a four-point contact ball bearing as the rolling bearing 7 has been increased.

Meanwhile, the recent CT scanner apparatus reduces a medical treatment-time to thereby reduce a burden on a patient. Thus, there has been an increasing need for speeding-up of the medical treatment. Consequently, high-speed rotation capability has been required of the four-point contact ball bearing used to as the rolling bearing 7.

However, it is hitherto general to set the axially internal gap of the four-point contact ball bearing at a positive value. In a use environment during a high speed rotation (dmN≧10000 where dm designates a ball PCD, and N denotes the number of revolutions), there is a fear that a slight bearing internal gap becomes a cause of noises and uncomfortable vibrations and puts a psychological burden on a patient or that the vibrations may cause an error of measurement accuracy.

Thus, there is proposed a technique of realizing a low-noise and low-vibration high-speed operation by setting the axially internal gap of the four-point contact ball bearing at a negative value (that is, corresponds to a state in which a preload is applied thereto) to thereby suppress the generation of noises and uncomfortable vibrations due to the internal gap (see, for example, Patent Document 1).

Also, a split retainer (see Patent Document 2) is proposed as the technique of realizing a low-noise and low-vibrations at the high-speed operation of the bearing by alleviate the noise and the impact of the collision between a ball and a retainer.

[Patent Document 1]

JP-A-2002-81442
   [Patent Document 2]
JP-A-2000-065067

However, in a case where the axially internal gap is simply set at a negative value, similarly to the four-point contact ball bearing described in the Patent Document 1, there is a high possibility of occurrence of a practically serious problem.

That is, in the four-point contact ball bearing, the balls are in two-point contact with each of the raceway surfaces of the outer and inner races. Thus, there are possibilities that excessive slip occurs at point contact portions between the balls and the raceway surfaces when the bearing rotates at a high speed under a preload applied thereto, and that this causes increase in friction torque, which is attended with heat generation and wear that may seriously impair the bearing life.

This problem cannot be solved even when the split retainer described in the Patent Document 2 is used.

Therefore, important future problems are to minimize slip occurring at the point contact portions between the balls and the raceway surfaces when the four-point contact ball bearing is rotated at a high speed under a preload applied thereto, thereby to prevent increase in friction torque, to reduce generated heat and wear, which are proportional to the friction torque, and to increase the bearing life.

Accordingly, an object of the invention is to solve the aforementioned problems, and to provide a four-point contact ball bearing enabled to suppress the heat generation and the wear thereof by restraining increase in friction torque in an operation under a preload applied thereto, and to realize a low-noise and low-vibration operation, which is performed at a high-speed rotation thereof, and enhancement of the bearing life thereof.

### DISCLOSURE OF INVENTION

1) The object of the invention is achieved by a four-point contact ball bearing including:
an outer member which has a raceway surface on an inner periphery thereof,
an inner member which has a raceway surface on an outer periphery thereof,
plural balls rollably disposed in a row between these outer and inner members, and
a retainer for disposing these plural balls at equal intervals in a circumferential direction thereof, the balls being in two-point contact with each of both raceway surfaces of the outer member and the inner member, wherein
if d designates a diameter of the ball, Dₚ designates a diameter of a pitch circle of the plural balls disposed between both the raceway surfaces, L₁ designates a distance between centers of adjacent ones of the balls on the pitch circle, r designates a curvature radius of each of grooves serving as the raceway surfaces circumscribing the ball, and α designates a contact angle between the ball and each of the raceway surfaces of the outer and inner races,
d, Dₚ, L₁, r, and α are set in such a way as to meet the following inequalities, respectively:
   0.011≦d/Dₚ≦0.017,
   1.5≦L₁/d≦2.1,
   0.54≦r/d≦0.59, and
   15°≦α≦25°; and
an axial gap S_{A} between the outer race and the inner race, which are in contact with each other through the ball, is set in such a way as to meet the following inequality:
   −0.050 mm≦S_{A}≦0 mm.

Incidentally, in the four-point contact ball bearing, a PV value obtained by a product of a contact surface pressure P, which is generated between the ball and each of the raceway surfaces, and a slip velocity V largely affects the degree of the wear of the ball and each of the raceway surfaces, and the level of noises generated during the rotation of the bearing. A low-noise and low-vibration operation of the bearing can be realized by reducing this PV value.

It is preferable for reducing the friction torque and the generated heat and the wear, which are attended therewith, by limiting the value of an inertia force, which acts on the ball during a high-speed rotation of the bearing, to a small value that the diameter d of the ball is set to be small as much as possible. However, when the diameter d of the ball is excessively small, the contact surface pressure P rises, so that the PV value increases. This causes reduction in the life.

Thus, according to the four-point contact ball bearing of the aforementioned configuration,
(1) The diameter d of the ball is set to be within a range represented by the inequality: 0.011≦d/Dₚ≦0.017. Consequently, this bearing avoids the diameter d of the ball from becoming excessively small. The PV value can be reduced by simultaneously suppressing the friction torque that incurs the heat generation and the wear of the bearing.
(2) It is necessary for ensuring the strength of column portion of the retainer between the balls to assure the area of a cross-section of the column portion of the retainer, which is equal to or more than a predetermined value. To that end, it is preferable to increase the inter-ball distance L₁. However, when the inter-ball distance L₁ is excessively large, the load shared by the individual balls is increased with the result that the PV value increases.

Thus, as described above, the inter-ball distance L1 is set to be within a range represented by the inequality: 1.5≦L₁/d≦2.1. Consequently, this bearing avoids the inter-ball distance L₁ from becoming excessively small. The PV value can be reduced by simultaneously ensuring the strength of the column portion of the retainer.
(3) The curvature radius r of each of the grooves serving as the raceway surfaces circumscribing the ball is set in an ordinary ball bearing to be set within a range represented by, for example, the following inequality: 0.5<r/d<0.54. Thus, the influence of variation in the gap due to a processing variation and a temperature change upon a bearing function can be alleviated by setting the curvature radius to be larger than a standard value. Further, the curvature radius r of the groove, with which the ball is in contact, is set to be larger than the standard value. Thus, the PV value can be reduced by simultaneously reducing the size of a contact oval produced between the ball and each of the raceway surfaces to thereby suppress differential slip and also suppressing the friction torque that incurs the heat generation and the wear of the bearing. However, when the curvature radius r is excessively set, a deviation between the ball and the raceway surface is liable to occur. Thus, it is difficult to achieve a stable operation.

Consequently, as described above, the curvature radius r of the groove is set to be within a range represented by the following inequality: 0.54≦r/d≦0.59. Thus, the curvature radius r of the groove can be prevented from being excessively increased. The size of the contact oval between the ball and each of the raceway surfaces can be restricted to a small size by simultaneously ensuring the workability of the bearing. Consequently, the PV value can be reduced by simultaneously suppressing the friction torque that incurs the heat generation and the wear of the bearing.
(4) When the contact angle α between the ball and each of the raceway surfaces is excessively small or large, a spin slip and a gyro slip increasingly occur with the result that the friction torque and the PV value are increased.

Thus, as described above, the contact angle α is set to be within the range represented by the following inequality: 15°≦α≦25°, so that the frequencies of occurrences of both the spin slip and the gyro slip can be reduced, and that the PV value can be reduced by simultaneously suppressing the friction torque that incurs the heat generation and the wear of the bearing.
(5) In a case where the axial gap S_{A} is set to be excessively negative value, the assemblability of the bearing may extremely be deteriorated, and the friction torque at the rotation thereof increase. These may be important causes of reduction in the bearing life. In an environment, in which synergetic effects of operations and advantages of the bearings of the aforementioned configurations (1) to (4) are obtained, a preload condition suitable for realizing a low-noise and low-vibration operation at a high-speed rotation of the bearing is obtained by setting the axial gap SA to be within the range represented by the following inequality: −0.050 mm≦SA≦0 mm. Consequently, the bearing life can be prevented from being reduced due to the heat generation and the wear thereof.

Therefore, the four-point contact ball bearing of the aforementioned configuration can restrain the friction torque from increasing in an operation under a preload applied thereto, thereby to suppress the heat generation and the wear of the bearing. Also, this ball bearing can realize a low-noise and low-vibration operation at a high-speed rotation of the bearing. Moreover, this ball bearing can achieve the increase in the bearing life by reducing the generated heat and the wear of the bearing.

2) The object of the invention is achieved by a four-point contact ball bearing including:
an outer member which has a raceway surface on an inner periphery thereof,
an inner member which has a raceway surface on an outer periphery thereof,
plural balls rollably disposed in a row between these outer and inner members, and
a retainer for disposing these plural balls at equal intervals in a circumferential direction thereof, the balls being in two-point contact with each of both raceway surfaces of the outer member and the inner member, wherein
each of the balls is formed of high-carbon chrome steel; and
a cabonitrided layer having Vickers hardness Hᵥ of 740 to 940 is formed on a surface of each of the balls.

3) The object of the invention is achieved by a four-point contact ball bearing including:
an outer member which has a raceway surface on an inner periphery thereof,
an inner member which has a raceway surface on an outer periphery thereof,
plural balls rollably disposed in a row between these outer and inner members, and
a retainer for disposing these plural balls at equal intervals in a circumferential direction thereof, the balls being in two-point contact with each of both raceway surfaces of the outer member and the inner member, wherein
the balls are made of martensitic stainless steel, and
a cabonitrided layer having Vickers hardness Hᵥ of 1200 to 1500 is formed on a surface of each of the balls.

4) The object of the invention is achieved by a four-point contact ball bearing including:
an outer member which has a raceway surface on an inner periphery thereof,
an inner member which has a raceway surface on an outer periphery thereof,
plural balls rollably disposed in a row between these outer and inner members, and
a retainer for disposing these plural balls at equal intervals in a circumferential direction thereof, the balls being in two-point contact with each of both raceway surfaces of the outer member and the inner member, wherein
the balls are made of engineering ceramics; and
a surface of each of the balls has Vickers hardness Hᵥ ranging from 1300 to 2700.

The four-point contact ball bearings described in the items 2) to 4) are such that the Vickers hardness of the surface of each of the balls is controlled in such a way as to be higher than the standard value.

Thus, the longitudinal elastic coefficient of the ball becomes high. Deformation of the ball, which is caused by the contact surface pressure acting between the ball and the raceway surface, is suppressed. Consequently, the contact oval produced between the ball and the raceway surface can be reduced in size. Thus, the differential slip occurring between the ball and each of the raceway surfaces can be minimized.

Further, due to the fact itself that the hardness of the surface of the ball is set to be higher than the standard value, the wear resistance thereof against a slip operation is enhanced. This enhancement of the wear resistance of the ball and the minimization of the differential slip enables the suppression of increase in the friction torque in an operation performed under a preload applied thereto. Thus, the generated heat and the wear of the bearing can be suppressed. Consequently, a low-noise and low-vibration operation at a high-speed rotation can be realized. Simultaneously, the enhancement of the bearing life can be realized by reducing the generated heat and the wear thereof.

### BRIEF DESCRIPTION OF DRAWINGS

FIG. 1 is a partially longitudinal cross-sectional view illustrating the configuration of a four-point contact ball bearing according to a first embodiment of the invention.

FIG. 2 is a comparison-measurement graph illustrating a test of sound levels at high speed rotations of the four-point contact ball bearing shown in FIG. 1, a conventional four-point contact ball bearing, and back-to-back combined angular ball bearings.

FIG. 3 is a comparison-measurement graph illustrating a test of vibration values at high speed rotations of the four-point contact ball bearing shown in FIG. 1, the conventional four-point contact ball bearing, and the back-to-back combined angular ball bearings.

FIG. 4 is a comparison-measurement graph illustrating a test of temperature rises at high speed rotations of the four-point contact ball bearing shown in FIG. 1, the conventional four-point contact ball bearing, and the back-to-back combined angular ball bearings.

FIG. 5 is a comparison-measurement graph illustrating a test of friction torques at high speed rotations of the four-point contact ball bearing shown in FIG. 1, the conventional four-point contact ball bearing, and the back-to-back combined angular ball bearings.

FIG. 6 is a comparison-measurement graph illustrating a test of lives at high speed rotations of the four-point contact ball bearing shown in FIG. 1, the conventional four-point contact ball bearing, and the back-to-back combined angular ball bearings.

FIG. 7 is a partially longitudinal cross-sectional view illustrating the configuration of a four-point contact ball bearing according to a second embodiment of the invention.

FIG. 8 is a partially longitudinal cross-sectional view illustrating the configuration of a four-point contact ball bearing according to a third embodiment of the invention.

FIG. 9 is a front view illustrating a shield plate shown in FIG. 8.

FIG. 10 is a partially longitudinal cross-sectional view illustrating the configuration of a four-point contact ball bearing according to a fourth embodiment of the invention.

FIG. 11 is a partially longitudinal cross-sectional view illustrating the configuration of a four-point contact ball bearing according to a fifth embodiment of the invention.

FIG. 12 is a radar graph for performance evaluation of a four-point contact ball bearing according to a sixth embodiment of the invention, two kinds of conventional four-point contact ball bearings differing in axial gap from each other, and the back-to-back combined angular ball bearing.

FIG. 13 is a cross-sectional view illustrating a primary part of a CT scanner apparatus using a rolling bearing.

FIG. 14 is a longitudinally cross-sectional view illustrating a back-to-back combined angular ball bearing used in the CT scanner apparatus.

Incidentally, in the figures, reference character 11 designates a four-point contact ball bearing, 13 denotes an outer race (or outer member), 15 designates an inner race (or inner member), 17 denotes a ball, and 19 designates a retainer.

### BEST MODE FOR CARRYING OUT THE INVENTION

Hereinafter, embodiments of the invention are described in detail with reference to the drawings.

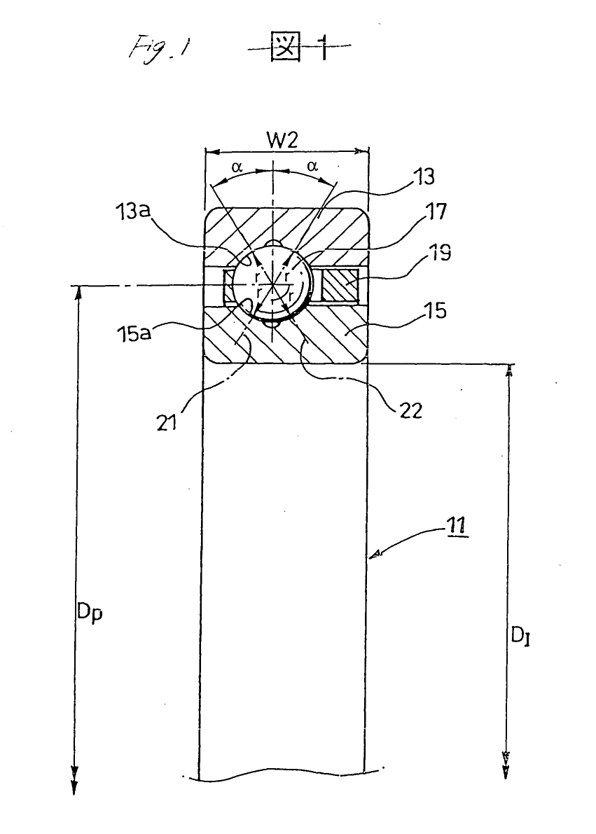

Hereunder, a four-point contact ball bearing according to an embodiment of the invention is described in detail with reference to the accompanying drawings. FIG. 1 is a partially longitudinal cross-sectional view illustrating the configuration of a four-point contact ball bearing according to the embodiment of the invention.

As shown in FIG. 1, a fourth-point contact ball bearing 11 according to this first embodiment of the invention has an outer race 13 serving as an outer member, which has a raceway surface 13a provided on an inner periphery thereof, an inner race 15 serving as an inner member, which has a raceway surface provided on the outer periphery thereof, plural balls 15 rollably disposed in a single row between the raceway surfaces 13a and 15a of the outer and inner races 13 and 15, and a retainer 19 for disposing these plural balls 17 at equal intervals in the circumferential direction thereof. The balls 17 are put in two-point contact with each of the raceway surfaces 13a and 15a of the outer and inner races 13 and 15.

Incidentally, as shown in FIG. 1, the intersection points between inclined dot-and-dash lines 21 and 22 and the raceway surfaces 13a and 15a are contact points between the balls 17 and the raceway surfaces 13a and 15a.

Further, the material of the balls 17 is high-carbon chrome steel. This is similar to that of the balls of the conventional bearing.

Furthermore, it is preferable for suppressing the wear thereof that surface hardening is performed on the balls and each of the raceway surfaces 13a and 15a. Any of a method of quenching and tempering thereof in high temperature oil, a rotational movement coil type induction hardening method, and an all-around coil type overall simultaneous induction hardening method (see, for example, JP-A-2002-174251) may be used as the hardening method performed at that time.

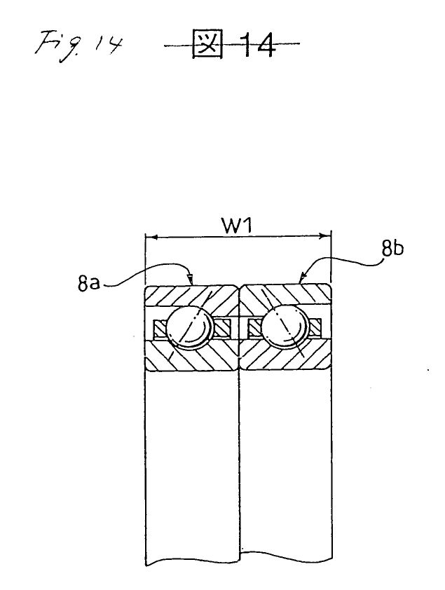

The four-point contact ball bearing 11 is utilized as a rolling bearing for rotatably supporting a cylindrical frame 6 of the CT scanner apparatus 1 shown in FIG. 13. The four-point contact ball bearing 11 having an inside diameter D₁, which is equal to or more than 700 mm, is formed in such a way as to have a large diameter. Thus, this four-point contact ball bearing 11 is what is called a ultrathin-walled rolling bearing, the section of which is extremely small, as compared with the diameter thereof.

Further, in the four-point contact ball bearing 11, let d designate a diameter of the ball 17. Let Dₚ denote a diameter of a pitch circle of the plural balls 17 disposed between both raceway surfaces 13a and 15a. Let L₁ designate a distance between the centers of the adjacent balls 17 (or an inter-ball distance) on the pitch circle. Let r denote a curvature radius of each of grooves serving as raceway surfaces 13a and 15a circumscribing the ball 17. Let α designate a contact angle between the ball 17 and each of the raceway surfaces 13a and 15a of the outer and inner races 13 and 15. In this embodiment, such d, Dₚ, L₁, r, and α are set in such a way as to meet the following inequalities \textcircled{1} to \textcircled{4}, respectively.
0.011≦d/Dₚ≦0.017 \textcircled{1}
1.5≦L₁/d≦2.1 \textcircled{2}
0.54≦r/d≦0.59 \textcircled{3}
15°≦α≦25° \textcircled{4}

Furthermore, an axial gap S_{A} between the outer race 13 and the inner race 15, which are in contact with each other through the ball 17, is set in such a way as to meet the following inequality:
−0.050 mm≦S_{A}≦0 mm.

Incidentally, in the four-point contact ball bearing 11, a PV value obtained by a product of a contact surface pressure P, which is generated between the ball 17 and each of the raceway surfaces 13a and 15a, and a slip velocity V largely affects the degree of the wear of the ball 17 and each of the raceway surfaces 13a and 15a, and the level of noises generated during the rotation of the bearing. A low-noise and low-vibration operation of the bearing can be realized by reducing this PV value.

Generally, it is preferable for reducing the friction torque and the generated heat and the wear, which are attended therewith, by limiting the value of an inertia force, which acts on the ball 17 during a high-speed rotation of the bearing, to a small value that the diameter d of the ball 17 is set to be small as much as possible. However, when the diameter d of the ball 17 is excessively small, the contact surface pressure P rises, so that the PV value increases. This causes reduction in the life.

Thus, according to the four-point contact ball bearing 11 of this embodiment,
(1) The diameter d of the ball 17 is set to be within a range represented by the inequality \textcircled{1}. Consequently, this embodiment avoids the diameter d of the ball 17 from becoming excessively small. The PV value can be reduced by simultaneously suppressing the friction torque that incurs the heat generation and the wear of the bearing.
(2) It is necessary for ensuring the strength of column portion of the retainer between the balls 17 to assure the area of a cross-section of the column portion of the retainer 19, which is equal to or more than a predetermined value. To that end, it is preferable to increase the inter-ball distance L₁. However, when the inter-ball distance L₁ is excessively large, the load shared by the individual balls 17 is increased with the result that the PV value increases.

Thus, according to this embodiment, the inter-ball distance L₁ is set to be within a range represented by the inequality \textcircled{2}. Consequently, this embodiment avoids the inter-ball distance L₁ from becoming excessively small. The PV value can be reduced by simultaneously ensuring the strength of the column portion of the retainer.
(3) The curvature radius r of each of the grooves serving as the raceway surfaces 13a and 15a circumscribing the ball 17 is set in an ordinary ball bearing to be set within a range represented by, for example, the following inequality: 0.5<r/d<0.54. Thus, the influence of variation in the gap due to a processing variation and a temperature change upon a bearing function can be alleviated by setting the curvature radius to be larger than a standard value. Further, the curvature radius r of the groove, with which the ball 17 is in contact, is set to be larger than the standard value. Thus, the PV value can be reduced by simultaneously reducing the size of a contact oval produced between the ball 17 and each of the raceway surfaces 13a and 15a to thereby suppress differential slip and also suppressing the friction torque that incurs the heat generation and the wear of the bearing. However, when the curvature radius r is excessively set, a deviation between the ball and the raceway surface is liable to occur. Thus, it is difficult to achieve a stable operation.

Consequently, in this embodiment, the curvature radius r of the groove is set to be within a range represented by the inequality \textcircled{3}. Thus, the curvature radius r of the groove can be prevented from being excessively increased. The size of the contact oval between the ball 17 and each of the raceway surfaces 13a and 15a can be restricted to a small size by simultaneously ensuring the workability of the bearing. Consequently, the PV value can be reduced by simultaneously suppressing the friction torque that incurs the heat generation and the wear of the bearing.
(4) When the contact angle α between the ball 17 and each of the raceway surfaces 13a and 15a is excessively small or large, a spin slip and a gyro slip increasingly occur with the result that the friction torque and the PV value are increased.

Thus, according to this embodiment, the contact angle α is set to be within the range represented by the inequality \textcircled{4}, so that the frequencies of occurrences of both the spin slip and the gyro slip can be reduced, and that the PV value can be reduced by simultaneously suppressing the friction torque that incurs the heat generation and the wear of the bearing.
(5) In a case where the axial gap S_{A} is set to be excessively negative value, the assemblability of the bearing may extremely be deteriorated, and the friction torque at the rotation thereof increase. These may be important causes of reduction in the bearing life. In an environment, in which synergetic effects of the setting according to the inequalities (1) to (4) are obtained, a preload condition suitable for realizing a low-noise and low-vibration operation at a high-speed rotation of the bearing is obtained by setting the axial gap SA to be within the range represented by the following inequality: −0.050 mm≦SA≦0 mm. Consequently, the bearing life can be prevented from being reduced due to the heat generation and the wear thereof.

That is, the four-point contact ball bearing 11 of this embodiment can restrain the friction torque from increasing in an operation under a preload applied thereto, thereby to suppress the heat generation and the wear of the bearing. Also, this embodiment can realize a low-noise and low-vibration operation at a high-speed rotation of the bearing. Moreover, this embodiment can achieve the increase in the bearing life by reducing the generated heat and the wear of the bearing.

Therefore, in a case where the four-point contact ball bearing is used in the CT scanner apparatus, this bearing meets the needs for speeding up an operation of the rotatably supporting portion. Also, noises and vibrations at a high-speed rotation of the bearing can be suppressed thereby to alleviate a psychological burden put on a patient and to prevent the measurement accuracy from being deteriorated by the vibrations.

Further, to check operations and effects of the aforementioned embodiment, characteristic evaluation tests, such as tests of noises (or sound levels thereof) generated at the high-speed rotation, vibration values, temperature rises, friction torques, and bearing lives, are performed on the four-point contact ball bearing according to this embodiment, the conventional four-point contact ball bearing, and the back-to-back combined angular ball bearing under the following test conditions. Incidentally, in the conventional four-point contact ball bearing, the axial gap is set at a positive value.

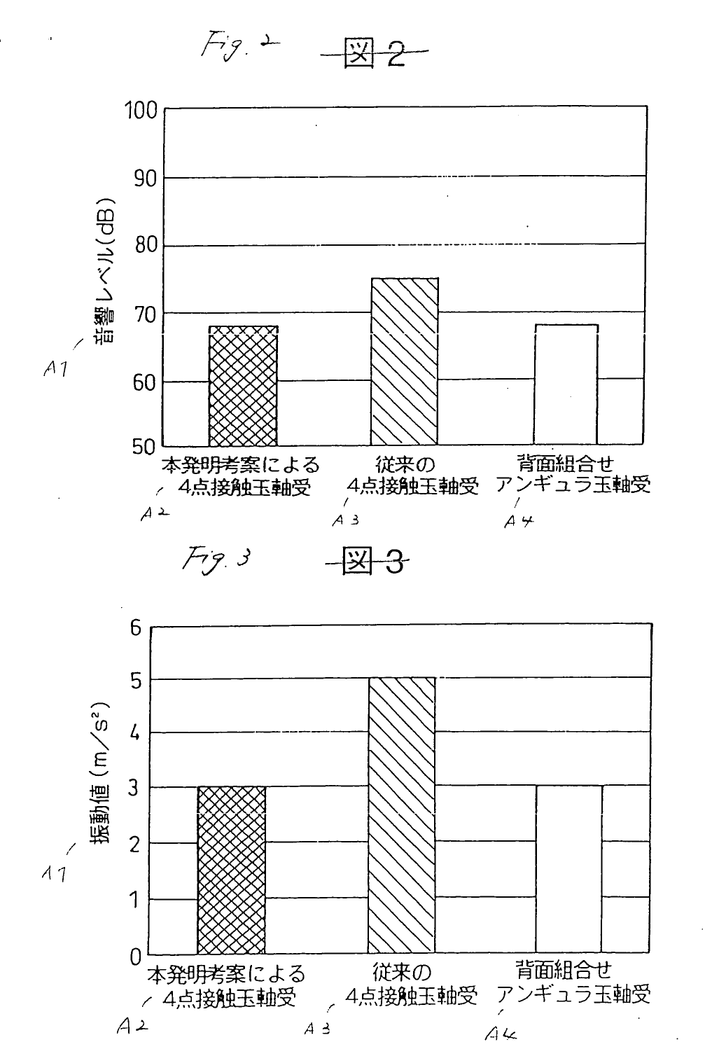

FIGS. 2 to 6 show results of such measurements.

(Test Conditions)
Radial Load=10000 (N)
Axial Load=6000 (N)
Moment Load=2000 (N-m)
Rotation Speed x Radius of Pitch Circle of Ball=160000 (min⁻¹·mm)

FIGS. 2 to 5 show that the four-point contact ball bearing 11 of this embodiment is superior to the conventional four-point contact ball bearing in any of characteristics exhibited by the tests of noises, vibration values, temperature rises, and friction torques, and that the four-point contact ball bearing 11 of this embodiment is comparable or better than the back-to-back combined angular ball bearing in such characteristics.

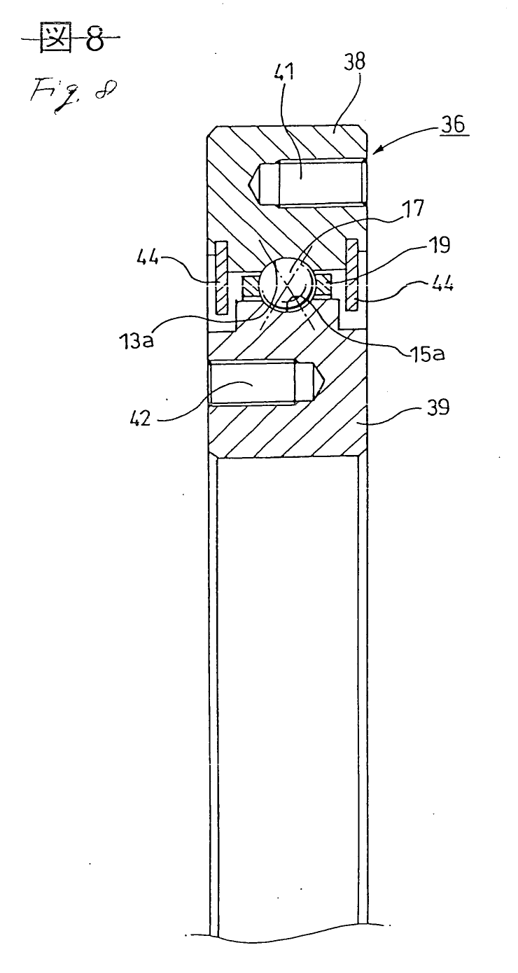

Further, as is seen from FIG. 6, the life of the four-point contact ball bearing 11 of this embodiment is comparable to those of the conventional four-point contact ball bearing to which no preload is applied, and the back-to-back combined angular ball bearing. Thus it is found that the application of a preload does not affect the reduction in the life.

FIG. 7 shows a four-point contact ball bearing according to a second embodiment of the invention.

As shown in FIG. 7, a four-point contact ball bearing 25 of the second embodiment is obtained by preliminarily assembling a journal box, which is used when assembled into the CT scanner apparatus, to the four-point contact ball bearing 11 of the first embodiment.

The journal box 27 comprises an outer-race-side journal box 31 for holding an outer race 13, and also comprises an inner-race-side journal box 32 for holding an inner race 15. Each of the outer-race-side journal box 31 and the inner-race-side journal box 32 comprises associated ones of bodies 31a and 32a, which can axially be separated from each other, caps 31b and 32b, and screw members 33 and 34.

Inner peripheral end portions of the body 31a and the cap 31b constituting the outer race side journal box 31 are equipped integrally with shield portions 31c, 31c overhanging inwardly radially.

The shield portions 31c, 31c covers opening portions at both ends of the four-point contact ball bearing 11 to thereby prevent grease, with which the four-point contact ball bearing 11 is filled, from leaking therefrom and also prevent foreign matters from entering the four-point contact ball bearing 11.

Furthermore, mounting holes for mounting the bearing in the CT scanner apparatus are provided in the outer-race-side journal box 31 and the inner-race-side journal box 32.

Thus, the four-point contact ball bearing 25 having a unit structure, in which the journal box 27 is preliminarily assembled to the four-point contact ball bearing 11, can enhance the assemblability thereof when assembled into the CT scanner apparatus.

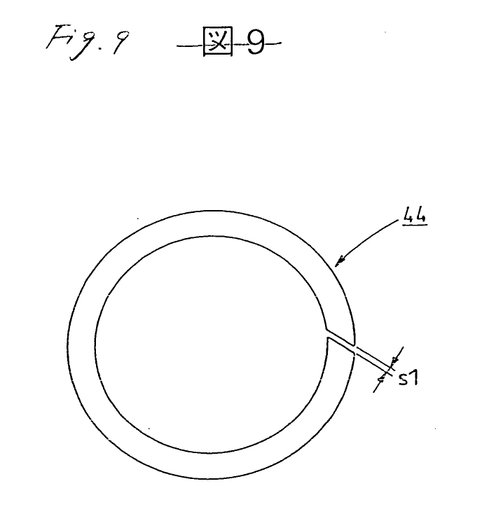

FIG. 8 shows a four-point contact ball bearing according to a third embodiment of the invention.

A four-point contact ball bearing 36 employs an outer member 38, instead of the outer race 13 of the four-point contact ball bearing 11 of the first embodiment, and is equipped with an inner member 39 instead of the inner race 15.

The outer member 38 is configured by forming the outer-race-side journal box 31 integrally with the outer race 13 of the second embodiment. Further, the inner member 39 is configured by forming the inner-race-side journal box 32 integrally with the outer race 15 of the second embodiment.

Therefore, in each of the outer member 38 and the inner member 39, an associated one of mounting screw portions 41 and 42 for securely fastening the bearing to the CT scanner apparatus is formed.

Also, ring-like shield plates 44 for preventing grease, with which the bearing is filled, from leaking and for preventing foreign matters from externally entering the bearing are attached to both inner peripheral end portions of the outer member 38.

Thus, parts serving as the inner and outer races of the bearing are formed integrally with the journal box. Components constituting the four-point contact ball bearing and the journal box, which are used in the CT scanner apparatus, can be reduced. The assemblability of the bearing to the CT scanner apparatus can be enhanced. The cost thereof can be reduced by reducing the components thereof.

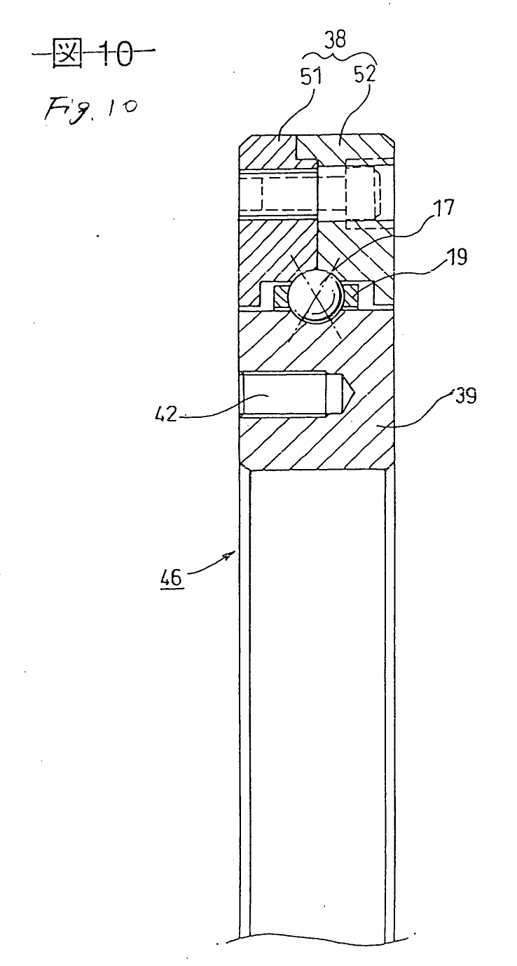

Further, as shown in FIG. 9, a gap s1, which is inclined to a radial direction by a predetermined inclination angle, for deforming the shield plate 44 by reducing the diameter thereof is preliminarily formed at a place on the circumference of the plate 44 shaped like a ring by performing press-molding on spring steel. Thus, the easiness of reducing the diameter of the plate 44 in an operation of assembling the bearing to the apparatus can be ensured. Simultaneously, reduction in the sealing ability, which is caused by opening the gap, can be suppressed.

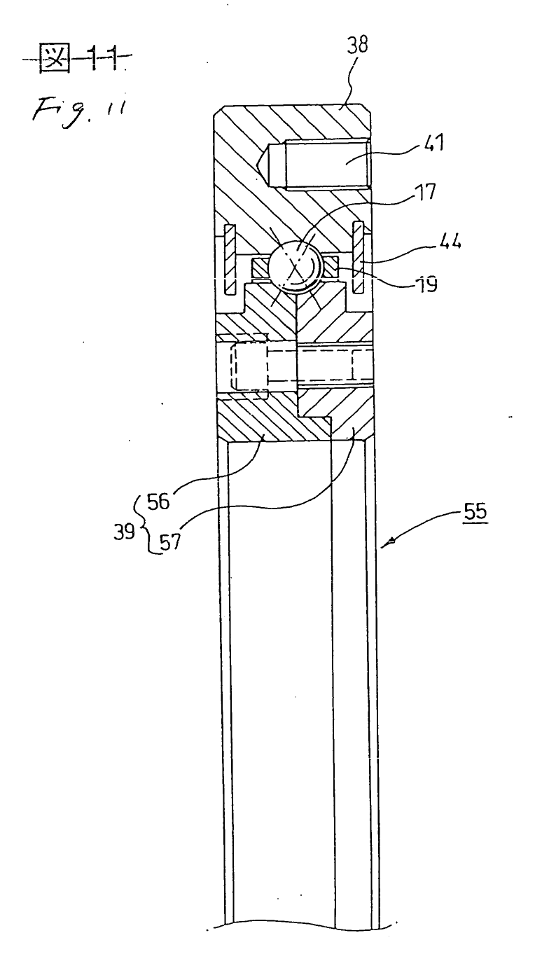

FIG. 10 shows a four-point contact ball bearing according to a fourth embodiment of the invention.

The four-point contact ball bearing 46 of this fourth embodiment is obtained by constituting the outer member 38 of the four-point contact ball bearing 36, which is the third embodiment shown in FIG. 8, from two ring-like members 51, 52, which can be axially separated from each other. The remaining constituents thereof are substantially the same as those of the four-point contact ball bearing of the third embodiment.

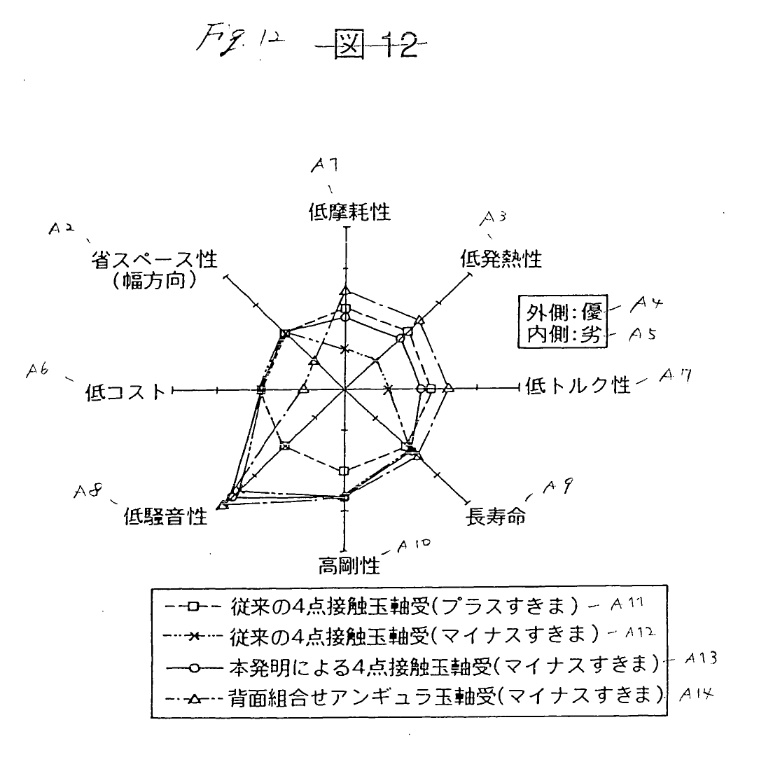

FIG. 11 shows a four-point contact ball bearing according to a fifth embodiment of the invention.

The four-point contact ball bearing 55 of this fifth embodiment is obtained by constituting the inner member 39 of the four-point contact ball bearing 36 of the third embodiment shown in FIG. 8 from two ring-like members 56 and 57, which can be axially separated from each other. The remaining constituents of the fifth embodiment are substantially the same as those of the four-point contact ball bearing 36 of the third embodiment.

In the case of the first to third embodiments, each of the inner and outer races cannot be divided. Therefore, the incorporating of the balls 17 thereinto is performed by elastically deforming the outer race, similarly to a deep-grooved ball bearing. Thus, the number of the balls 17 incorporated by utilizing the material of the outer race at the elastic limit thereof is limited.

Meanwhile, in the case of the four-point contact ball bearings 46 and 55 of the fourth and fifth embodiments shown in FIGS. 10 and 11, at least one of the inner and outer races is bisected. The number of the balls 17 incorporated into between the inner and outer races is limited only by the dimensions of the column portion of the retainer 19, which are necessary for ensuring the strength thereof. However, the number of the incorporated balls 17 relates to neither the elastic limit of the outer member functioning as the outer race nor the elastic limit of the inner member functioning as the inner race.

Therefore, as compared with the four-point contact ball bearings of the first to third embodiments, a larger number of balls 17 can be incorporated into each of the four-point contact ball bearings 46 and 55 of the fourth and fifth embodiments. The durability and the life of the bearing can be achieved by reducing a load, which acts on a ball 17, or by increasing an allowable load.

Incidentally, in the case of the four-point contact ball bearings of the first to fifth embodiments, the aforementioned dimensions are set to be within the ranges represented by the inequalities \textcircled{1} to \textcircled{4}. And, the axial gap S_{A} is set in such a way as to meet the range: −0.050 mm≦S_{A}≦0 mm. Thus, a low-noise and low-vibration operation at a high-speed rotation is realized. Also, the suppression of the generated heat and the wear of the bearing at a high-speed operation under the preload applied thereto is realized.

In contrast with this, four-point contact ball bearings of the following sixth to eighth embodiments can obtain operations and effects, which are similar to the aforementioned embodiments.

A four-point contact bearing, which is a sixth embodiment, is configured so that the balls are made of high-carbon chrome steel, and that a cabonitrided layer having Vickers hardness Hᵥ of 740 to 940 is formed on the surface of each of the balls.

Further, a four-point contact bearing, which is a seventh embodiment, is configured so that the balls are made of martensitic stainless steel, and that a cabonitrided layer having Vickers hardness Hᵥ of 1200 to 1500 is formed on the surface of each of the balls.

Furthermore, a four-point contact bearing, which is an eighth embodiment, is configured so that the balls are made of engineering ceramics, and that the surface of each of the balls has Vickers hardness Hᵥ ranging from 1300 to 2700.

These four-point contact ball bearings of the sixth to eighth embodiments are such that the Vickers hardness of the surface of each of the balls is controlled in such a way as to be higher than the standard value.

Thus, the longitudinal elastic coefficient of the ball becomes high. Deformation of the ball, which is caused by the contact surface pressure acting between the ball and the raceway surface, is suppressed. Consequently, the contact oval produced between the ball and the raceway surface can be reduced in size. Thus, the differential slip occurring between the ball and each of the raceway surfaces can be minimized.

Further, due to the fact itself that the hardness of the surface of the ball is set to be higher than the standard value, the wear resistance thereof against a slip operation is enhanced. This enhancement of the wear resistance of the ball and the minimization of the differential slip enables the suppression of increase in the friction torque in an operation performed under a preload applied thereto. Thus, the generated heat and the wear of the bearing can be suppressed. Consequently, a low-noise and low-vibration operation at a high-speed rotation can be realized. Simultaneously, the enhancement of the bearing life can be realized by reducing the generated heat and the wear thereof.

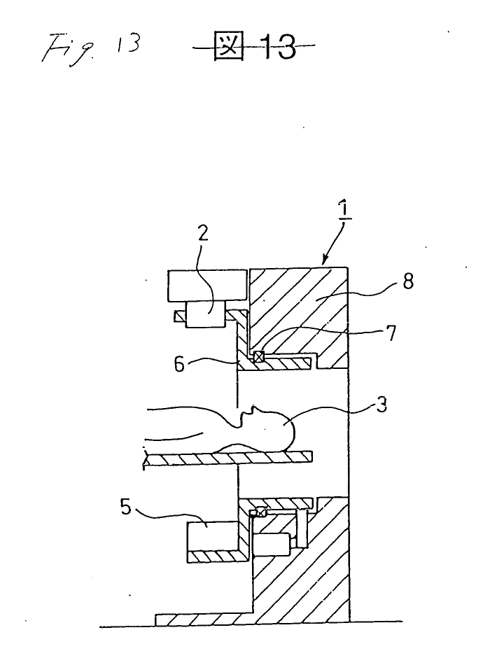

FIG. 12 shows results of comparison in various characteristics of a bearing among the four-point contact ball bearings of the sixth to eighth embodiments, which enhances the Vickers hardness Hᵥ of the surface of the ball and sets the axial gap S_{A} in the bearing at a negative value, the conventional contact ball bearing, and the back-to-back combined angular ball bearing.

Incidentally, the measurement of the characteristics is performed on two kinds of the conventional four-point contact ball bearings, that is, one kind of which is adapted so that the axial gap is set at a negative value, and the other kind of which is adapted so that the axial gap is set at a positive value.

Consequently, as compared with the back-to-back combined angular ball bearing, the four-point contact ball bearing of the present invention is superior in the space saving ability and the low cost thereto. Further, as compared with the conventional four-point contact ball bearing, the four-point contact ball bearing of the present invention is superior in the low noise and the life of the bearing thereto. The aforementioned operations and effects can be confirmed.

### INDUSTRIAL APPLICABILITY

As described above, according to the invention,
(1) the diameter d of the ball is set in the range represented by the following inequality: 0.011≦d/Dₚ≦0.017. Thus, the diameter of the ball is avoided from becoming excessively small. Consequently, the PV value can be reduced by simultaneously suppressing the friction torque that incurs the heat generation and the wear of the bearing.
(2) The inter-ball distance L₁ is set in the range represented by the following inequality: 1.5≦L₁/d≦2.1. Thus, the inter-ball distance L₁ is avoided from becoming excessively large. Consequently, the PV value can be reduced by simultaneously ensuring the strength of the column portion of the retainer.
(3) The curvature radius r of the groove is set in the range represented by the following inequality: 0.54≦r/d≦0.59. The curvature radius of the groove can be avoided from excessively large. Consequently, the contact oval produced between the ball and the raceway surface is suppressed to a small size by simultaneously ensuring the workability. Consequently, the PV value can be reduced by simultaneously suppressing the friction torque, which incurs the heat generation and the wear of the bearing.
(4) The contact angle α between the ball and each of the raceway surfaces is restricted within the range represented by the following inequality: 15°≦α≦25°. Thus, the PV value can be reduced by simultaneously reducing both the spin slip between the ball and the raceway surface and the gyro slip therebetween and suppressing the friction torque that incurs the heat generation and the wear of the bearing.
(5) In the environment, in which the synergetic effects of the operations and advantages of obtaining the characteristics according to the dimensions represented by the items (1) to (4), a preload condition suitable for realizing a low-noise and low-vibration operation at a high-speed rotation of the bearing is obtained by setting the axial gap SA to be within the range represented by the following inequality: −0.050 mm≦SA≦0 mm. Consequently, the bearing life can be prevented from being reduced due to the heat generation and the wear thereof.

Furthermore, according to the four-point contact ball bearings described in the items 2) to 4), the Vickers hardness Hᵥ of the surface of the ball is controlled in such a way as to be higher than the standard value. Thus, the longitudinal elastic coefficient of the ball becomes high. The deformation of the ball, which is caused by the contact pressure between the ball and the raceway surface, can be suppressed. Thus, the size of the contact oval produced between the ball and the raceway surface can be reduced to a small one. Consequently, the differential slip occurring between the ball and each of the raceway surface can be minimized.

Additionally, the setting itself of the hardness of the surface of the ball enhances the wear resistance against a slip operation. This enhancement of the wear resistance and the minimization of the differential slip can suppress the increase in the friction torque in the operation performed under the applied preload. Thus, the heat generation and the wear of the bearing can be suppressed. Moreover, a low-noise and low-vibration at the high-speed rotation can be realized. Simultaneously, the enhancement of the bearing life can be realized by reducing the generated heat and the wear of the bearing.

[FIG. 2]

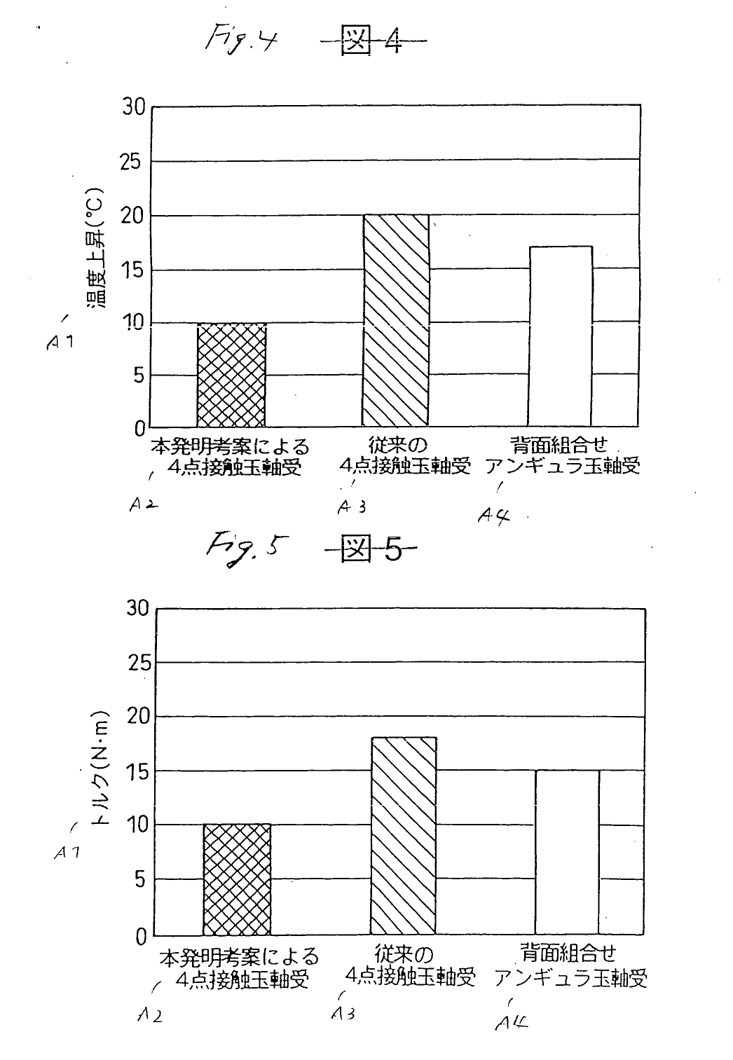

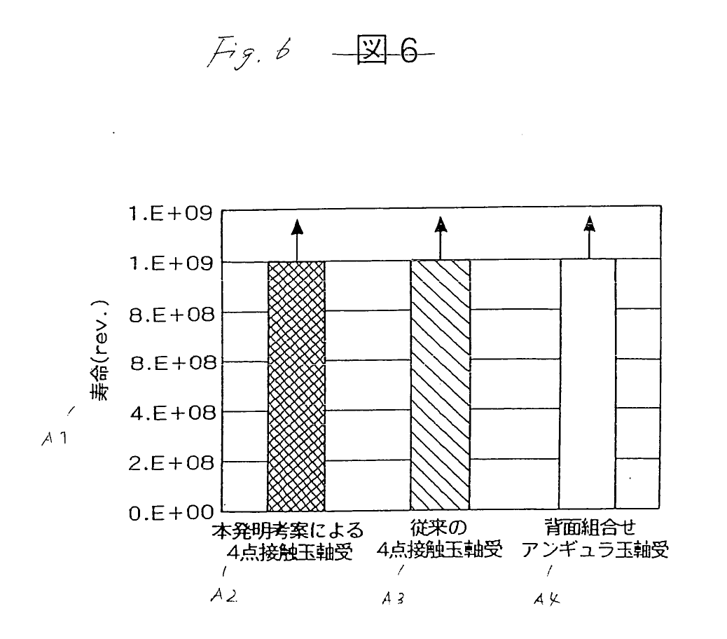

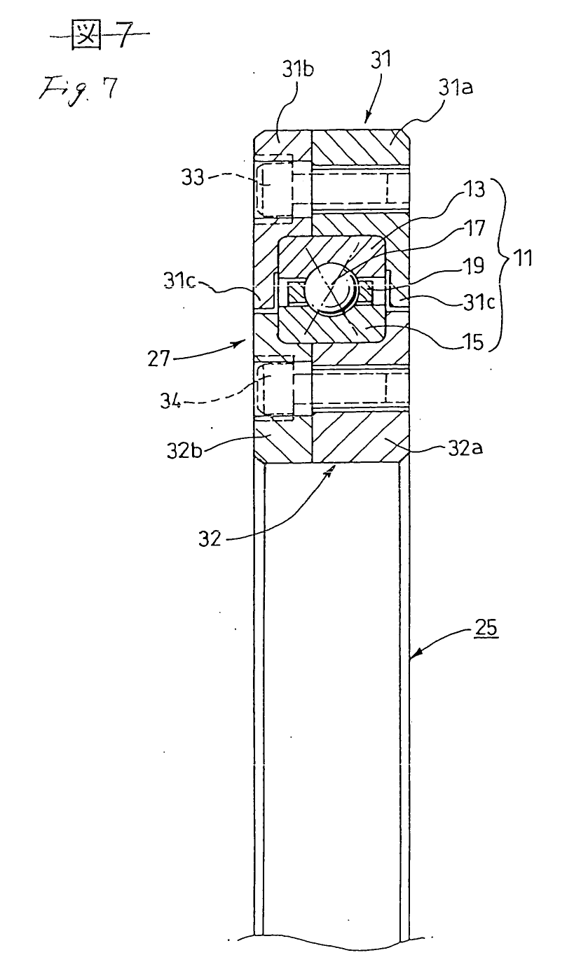

A1: SOUND LEVEL
A2: 4-POINT CONTACT BALL BEARING ACCORDING TO THE PRESENT INVENTION
A3: CONVENTIONAL 4-POINT CONTACT BALL BEARING
A4: BACK-TO-BACK COMBINED ANGULAR BALL BEARING
   [FIG. 3]
A1: VIBRATION VALUE
A2: 4-POINT CONTACT BALL BEARING ACCORDING TO THE PRESENT INVENTION
A3: CONVENTIONAL 4-POINT CONTACT BALL BEARING
A4: BACK-TO-BACK COMBINED ANGULAR BALL BEARING
   [FIG. 4]
A1: TEMPERATURE RISE
A2: 4-POINT CONTACT BALL BEARING ACCORDING TO THE PRESENT INVENTION
A3: CONVENTIONAL 4-POINT CONTACT BALL BEARING
A4: BACK-TO-BACK COMBINED ANGULAR BALL BEARING
   [FIG. 5]
A1: TORQUE
A2: 4-POINT CONTACT BALL BEARING ACCORDING TO THE PRESENT INVENTION
A3: CONVENTIONAL 4-POINT CONTACT BALL BEARING
A4: BACK-TO-BACK COMBINED ANGULAR BALL BEARING
   [FIG. 6]
A1: LIFE
A2: 4-POINT CONTACT BALL BEARING ACCORDING TO THE PRESENT INVENTION
A3: CONVENTIONAL 4-POINT CONTACT BALL BEARING
A4: BACK-TO-BACK COMBINED ANGULAR BALL BEARING
   [FIG. 12]
A1: LOW WEAR
A2: (WIDTHWISE) SPACE SAVING ABILITY
A3: LOW CALORIFICATION
A4: OUTER: SUPERIOR
A5: INNER: INFERIOR
A6: LOW COST
A7: LOW TORQUE
A8: LOW NOISE
A9: LONG LIFE
A10: HIGH RIGIDITY
All: CONVENTIONAL 4-POINT CONTACT BALL BEARING (POSITIVE GAP)
A12: CONVENTIONAL 4-POINT CONTACT BALL BEARING (NEGATIVE GAP)
A13: 4-POINT CONTACT BALL BEARING ACCORDING TO THE PRESENT INVENTION (NEGATIVE GAP)
A14: BACK-TO-BACK COMBINED ANGULAR BALL BEARING (NEGATIVE GAP)

1. A four-point contact ball bearing comprising:
an outer member which has a raceway surface on an inner periphery thereof,
an inner member which has a raceway surface on an outer periphery thereof,
plural balls rollably disposed in a row between these outer and inner members, and
a retainer for disposing these plural balls at equal intervals in a circumferential direction thereof, the balls being in two-point contact with each of both raceway surfaces of the outer member and the inner member, wherein
if d designates a diameter of the ball, Dₚ designates a diameter of a pitch circle of the plural balls disposed between both the raceway surfaces, L₁ designates a distance between centers of adjacent ones of the balls on the pitch circle, r designates a curvature radius of each of grooves serving as the raceway surfaces circumscribing the ball, and α designates a contact angle between the ball and each of the raceway surfaces of the outer and inner races,
d, Dₚ, L₁, r, and α are set in such a way as to meet the following inequalities, respectively:
0.011≦d/Dₚ≦0.017,
1.5≦L₁/d≦2.1,
0.54≦r/d≦0.59, and
15°≦α≦25°; and
an axial gap S_{A} between the outer race and the inner race, which are in contact with each other through the ball, is set in such a way as to meet the following inequality:
−0.050 mm≦S_{A}≦0 mm.

2. A four-point contact ball bearing comprising:
an outer member which has a raceway surface on an inner periphery thereof,
an inner member which has a raceway surface on an outer periphery thereof,
plural balls rollably disposed in a row between these outer and inner members, and
a retainer for disposing these plural balls at equal intervals in a circumferential direction thereof, the balls being in two-point contact with each of both raceway surfaces of the outer member and the inner member, wherein
each of the balls is formed of high-carbon chrome steel; and
a cabonitrided layer having Vickers hardness Hᵥ of 740 to 940 is formed on a surface of each of the balls.

3. A four-point contact ball bearing comprising:
an outer member which has a raceway surface on an inner periphery thereof,
an inner member which has a raceway surface on an outer periphery thereof,
plural balls rollably disposed in a row between these outer and inner members, and
a retainer for disposing these plural balls at equal intervals in a circumferential direction thereof, the balls being in two-point contact with each of both raceway surfaces of the outer member and the inner member, wherein
the balls are made of martensitic stainless steel; and
a cabonitrided layer having Vickers hardness Hᵥ of 1200 to 1500 is formed on a surface of each of the balls.

4. A four-point contact ball bearing comprising:
an outer member which has a raceway surface on an inner periphery thereof,
an inner member which has a raceway surface on an outer periphery thereof,
plural balls rollably disposed in a row between these outer and inner members, and
a retainer for disposing these plural balls at equal intervals in a circumferential direction thereof, the balls being in two-point contact with each of both raceway surfaces of the outer member and the inner member, wherein
the balls are made of engineering ceramics; and
a surface of each of the balls has Vickers hardness Hᵥ ranging from 1300 to 2700.
